(19) United States
(12) Patent Application Publication
(10) Pub. No.: US 2021/0073476 A1
(43) Pub. Date: Mar. 11, 2021

(54) RECORDING MEDIUM, CONVERSATION CONTROL METHOD, AND INFORMATION PROCESSING APPARATUS

(71) Applicant: FUJITSU LIMITED, Kawasaki-shi (JP)

(72) Inventors: Shinji Narukawa, Ohta (JP); Hiroshi Matsuyama, Ota (JP)

(73) Assignee: FUJITSU LIMITED, Kawasaki-shi (JP)

(21) Appl. No.: 17/101,519

(22) Filed: Nov. 23, 2020

Related U.S. Application Data
(63) Continuation of application No. PCT/JP2019/021783, filed on May 31, 2019.

(51) Int. Cl. G06F 40/35; H04L 12/58; G06K 19/06; G06K 7/14; G06Q 30/06

(52) U.S. Cl. CPC G06F 40/35; H04L 51/02; G06K 19/06037; G06Q 50/26; G06Q 30/0613; G06Q 30/0631; G06K 7/1417

(57) ABSTRACT

A computer-readable recording medium stores therein a program causing a computer to execute a process including receiving, from a first information processing terminal, a start instruction for a chat and identification information corresponding to the first information processing terminal; determining, based on the received identification information, a first script to be applied to a first conversation performed by a chatbot via the first information processing terminal, and starting the first conversation performed by the chatbot via the first information processing terminal, using the determined first script; and when receiving, from a second information processing terminal, transfer information that indicates transfer from the first conversation, determining, based on the received transfer information, a second script to be applied to a second conversation performed by the chatbot via the second information processing terminal, and starting the second conversation, using the determined second script, the second conversation being performed, following the first conversation.

### CROSS REFERENCE TO RELATED APPLICATIONS

This application is a continuation application of International Application PCT/JP2019/021783, filed on May 31, 2019 and designating the U.S., the entire contents of which are incorporated herein by reference.

### FIELD

The embodiments discussed herein relate to a recording medium, a conversation control method, and an information processing apparatus.

### BACKGROUND

Recently, digital boards capable of bilateral communication coordinated with a chatbot have begun to be used. For example, digital boards are used to provide shop or facility information. Further, digital boards are expected to be installed in highly public places such as in cities, governmental offices, transit stations, etc. for use by a large number of unspecified persons.

As a prior art, for example, there is a device for enabling clients to interact with a public signage display to obtain additional information regarding a product or service at a retail location, etc. For an example, refer to Published Japanese-Translation of PCT Application, Publication No. 2011-525277.

### SUMMARY

According to an aspect of an embodiment, a computer-readable recording medium has stored therein a program for causing a computer to execute a process including receiving, from a first information processing terminal, a start instruction for a chat and identification information corresponding to the first information processing terminal; determining, based on the received identification information, a first script to be applied to a conversation performed by a chatbot via the first information processing terminal, and starting a first conversation performed by the chatbot via the first information processing terminal, using the determined first script; and when receiving, from a second information processing terminal, transfer information that indicates transfer from the first conversation, determining, based on the received transfer information, a second script to be applied to the conversation performed by the chatbot via the second information processing terminal, and starting a second conversation performed by the chatbot, using the determined second script, the second conversation being performed via the second information processing terminal, following the first conversation.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of a conversation control method according to an embodiment.

FIG. 2 is a diagram of an example of system configuration of a conversation control system 200.

FIG. 3 is a block diagram of an example of a hardware configuration of an information processing apparatus 101.

FIG. 4 is a block diagram of an example of a hardware configuration of a first information processing terminal 201, etc.

FIG. 5 is a diagram of an example of stored contents of the script table 220.

FIG. 6 is a diagram of a specific example of a script.

FIG. 7 is a block diagram of an example of a functional configuration of the information processing apparatus 101.

FIG. 8 is a diagram of an example of stored contents of a script transfer table 800.

FIG. 9A is a diagram of a screen example of a conversation screen displayed by the first information processing terminal 201.

FIG. 9B is a diagram of a screen example of a conversation screen displayed by the first information processing terminal 201.

FIG. 10A1 is a diagram of a screen example of a conversation screen of a second information processing terminal 202.

FIG. 10A2 is a diagram of a screen example of a conversation screen of a second information processing terminal 202.

FIG. 10B1 is a diagram of a screen example of a conversation screen of a second information processing terminal 202.

FIG. 10B2 is a diagram of a screen example of a conversation screen of a second information processing terminal 202.

FIG. 10C1 is a diagram of a screen example of a conversation screen of a second information processing terminal 202.

FIG. 10C2 is a diagram of a screen example of a conversation screen of a second information processing terminal 202.

FIG. 11 is a flowchart of an example of a procedure of a first conversation control process of the information processing apparatus 101.

FIG. 12 is a flowchart of an example of a procedure of a second conversation control process of the information processing apparatus 101.

### DESCRIPTION OF THE INVENTION

First, problems associated with the conventional techniques are discussed. With the conventional techniques, provision of a service that uses bidirectional communication coordinated with a chatbot using digital boards, etc. installed at a place where a large number of unspecified users are expected to use the service may be limited.

Embodiments of a conversation control program, a conversation control method, and an information processing apparatus are described in detail with reference to the accompanying drawings.

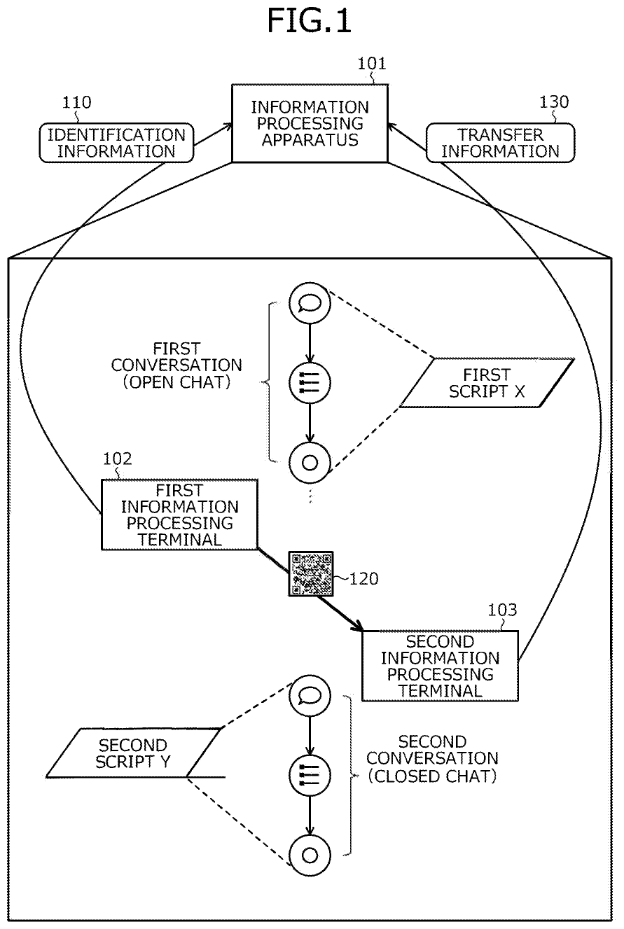

FIG. 1 is a diagram depicting an example of a conversation control method according to an embodiment. In FIG. 1, an information processing apparatus 101 is a computer that controls a conversation of a chatbot. The chatbot is a computer system that uses artificial intelligence to interact and exchange messages with humans.

A first information processing terminal 102 is a stationary computer used when a user converses with the chatbot. For example, the first information processing terminal 102 is a public terminal such as a digital board installed in a highly public place and used by a large number of unspecified persons.

A second information processing terminal 103 is a portable computer used when a user converses with the chatbot. For example, the second information processing terminal 103 is a smartphone, a tablet personal computer (PC), etc. of an individual.

Here, use of the first information processing terminal 102 to provide a service using bidirectional communication coordinated with the chatbot is conceivable. Such a service may be, for example, introducing a recommended shop or facility, handling inquiries and applications from citizens visiting a governmental office, etc.

Nonetheless, the first information processing terminal 102 is assumed to be installed in a highly public place for use by a large number of unspecified persons, and prolonged use thereof by a single individual is undesirable. Further, input of personal information into the first information processing terminal 102 that is installed in a highly public place is undesirable.

Thus, in the present embodiment, a conversation control method that facilitates smooth provision of a service using a chatbot by enabling transfer of a chat between different apparatuses will be described. Herein, an example of a process by the information processing apparatus 101 will be described.

(1) The information processing apparatus 101 receives, from the first information processing terminal 102, a start instruction for a chat and receives identification information corresponding to the first information processing terminal 102. Here, the start instruction for a chat is for starting a conversation between a user and the chatbot.

The identification information corresponding to the first information processing terminal 102 is information for determining a script to be applied to a conversation performed by the chatbot via the first information processing terminal 102. The script is information (a scenario) that defines a flow of the conversation performed by the chatbot. In particular, for example, the script is information defining a flow of a talk process of a chat.

The talk process is a process for realizing operation (behavior) of the chatbot. For example, the talk process includes a process of starting the talk process, a process of speaking, a process of displaying options, a process of selecting an option according to a user operation, a process of performing procedures according to the selected option, a process of ending the talk process, etc.

The identification information corresponding to the first information processing terminal 102 may be information uniquely identifying the first information processing terminal 102. Further, the identification information corresponding to the first information processing terminal 102 may be information indicating that the first information processing terminal 102 is installed in a highly public place. Further, the identification information corresponding to the first information processing terminal 102 may be information identifying a state or a characteristic of a user of the first information processing terminal 102.

A characteristic of a user of the first information processing terminal 102, for example, is the age, gender, etc. of a user who is using the first information processing terminal 102. Further, a state of the user of the first information processing terminal 102, for example, is a current location of or the weather at the current location of the user. Nonetheless, the first information processing terminal 102 is a stationary computer. Therefore, the current location of the user who is using the first information processing terminal 102 is equivalent to an installation location of the first information processing terminal 102.

In the example depicted in FIG. 1, an instance is assumed in which from the first information processing terminal 102, a start instruction for a chat and identification information 110 that corresponds to the first information processing terminal 102 is received.

(2) The information processing apparatus 101 begins a first conversation performed by the chatbot via the first information processing terminal 102, based on the received identification information that corresponds to the first information processing terminal 102. In particular, for example, the information processing apparatus 101 determines a first script based on the received identification information 110 that corresponds to the first information processing terminal 102.

The first script is a script to be applied to the conversation performed by the chatbot via the first information processing terminal 102. The information processing apparatus 101 uses the determined first script and starts the first conversation. At the first information processing terminal 102, the user converses with the chatbot by selecting an option, inputting a message, etc.

For example, the identification information 110 is assumed to be a terminal ID that uniquely identifies the first information processing terminal 102. In this instance, the information processing apparatus 101, for example, may determine, as the first script, a script stored in advance associated with the terminal ID of the first information processing terminal 102.

Further, the identification information 110 is assumed to be information indicating that the first information processing terminal 102 is installed at a highly public place. In this instance, the information processing apparatus 101, for example, may determine, as the first script, a script stored in advance for a terminal installed in a highly public place.

Further, the identification information 110 is assumed to be information identifying a state or characteristic of the user of the first information processing terminal 102. In this instance, the information processing apparatus 101, for example, may determine, as the first script, a script that corresponds to the state or characteristic of the user of the first information processing terminal 102, among scripts stored in advance corresponding to states and/or characteristics of users.

In the example in FIG. 1, an instance is assumed in which a first script X is determined based on the identification information 110. In this instance, the information processing apparatus 101 uses the first script X and starts a first conversation performed by the chatbot via the first information processing terminal 102. The first conversation is a conversation by an open chat performed at a highly public place. In the open chat, for example, no questions related to highly confidential personal information are asked.

(3) The information processing apparatus 101 receives transfer information from the second information processing terminal 103. Here, the transfer information is information indicating a transfer from the first conversation. The transfer information, for example, includes information identifying the first script. Further, the transfer information may include information that identifies a point where the first conversation was suspended, a conversation history of the first conversation, etc.

The second information processing terminal 103, for example, reads transfer guidance output from the first information processing terminal 102 and thereby obtains transfer information that indicates transfer from the first conversation performed via the first information processing terminal 102 with the chatbot. In other words, the transfer information is obtained based on the transfer guidance read by the second information processing terminal 103.

The transfer guidance prompts suspension of the conversation by open chat and continuation of the conversation by a closed chat. In the closed chat, for example, questions about personal information that is more confidential than information in an open chat may be asked.

For example, when contents of the conversion satisfy a predetermined condition after the first conversation starts, the transfer guidance is output from the first information processing terminal 102. More specifically, for example, the transfer guidance is displayed by the first information processing terminal 102 as a two-dimensional code such as a Quick Response (QR) code. QR code is a registered trademark.

In the example in FIG. 1, the second information processing terminal 103 is assumed to read a QR code 120 displayed by the first information processing terminal 102 and thereby, obtain transfer information 130 indicating transfer from the first conversation with the chatbot performed via the first information processing terminal 102. Further, an instance in which the information processing apparatus 101 receives the transfer information 130 from the second information processing terminal 103 is assumed.

(4) When the information processing apparatus 101 receives transfer information from the second information processing terminal 103, the information processing apparatus 101 starts, based on the transfer information, a second conversation performed by the chatbot via the second information processing terminal 103, following the first conversation. In particular, for example, the information processing apparatus 101 determines a second script based on the received transfer information 130.

The second script is a script to be applied to the conversation performed by the chatbot via the second information processing terminal 103. Subsequently, the information processing apparatus 101 uses the determined second script and starts the second conversation that follows the first conversation. At the second information processing terminal 103, the user selects an option and/or inputs a message and thereby, converses with the chatbot.

For example, the transfer information 130 is assumed to include information that identifies the first script X. In this instance, for example, the information processing apparatus 101 may determine, as the second script, a script stored in advance associated with the first script X.

Further, the transfer information 130 is assumed to include information identifying the first script X and information identifying a point (transfer point) where the first conversation was suspended. In this instance, for example, as the second script, the information processing apparatus 101 may determine from among scripts stored in advance associated with transfer points of the first script X, a script that corresponds to the transfer point identified from the transfer information 130.

The second script may define a flow of the conversation after the transfer point in the first script. In other words, the first script after the transfer point may be used as the second script rather than independently preparing the first script and the second script.

In the example in FIG. 1, a second script Y from the transfer information 130 is assumed to be determined. In this instance, the information processing apparatus 101 uses the second script Y and starts the second conversation performed by the chatbot via the second information processing terminal 103, following the first conversation. The second conversation is a conversation by a closed chat.

In this manner, according to the information processing apparatus 101, transfer of a chat is possible between different apparatuses. In particular, for example, according to the information processing apparatus 101, the transfer of a conversation from an open chat performed using the first information processing terminal 102, to a closed chat performed using the second information processing terminal 103 is possible. Therefore, situations in which the first information processing terminal 102 that is assumed to be installed in a highly public place for use by a large number of unspecified persons is used for a prolonged period by a single individual may be prevented, thereby facilitating smooth provision of services using the chatbot.

In the example in FIG. 1, the first conversation with the chatbot started via the first information processing terminal 102 and using the first script X is suspended and the second conversation performed by the chatbot via the second information processing terminal 103 is started using the second script Y, following the first conversation.

An example of system configuration of a conversation control system 200 that includes the information processing apparatus 101 depicted in FIG. 1 is described.

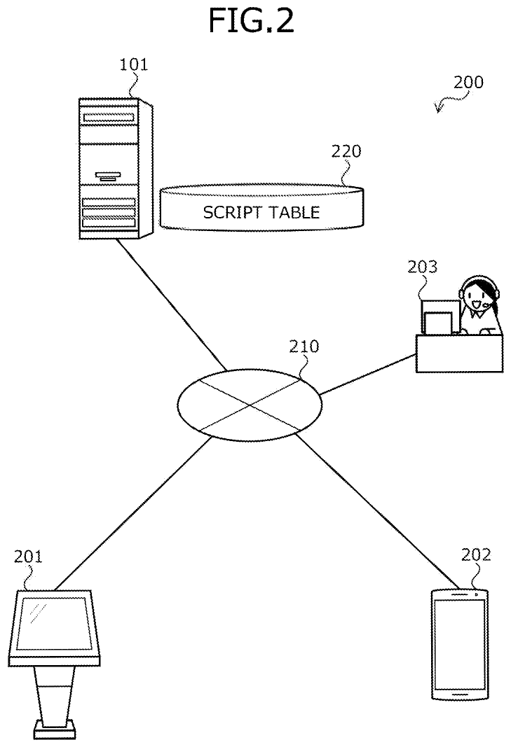

FIG. 2 is a diagram of an example of system configuration of the conversation control system 200. In FIG. 2, the conversation control system 200 includes the information processing apparatus 101, a first information processing terminal 201, a second information processing terminal 202, and an operator terminal 203. In the conversation control system 200, the information processing apparatus 101, the first information processing terminal 201, the second information processing terminal 202, and the operator terminal 203 are connected through a network 210 that may be wired or wireless. The network 210, for example, is a local area network (LAN), a wide area network (WAN), the Internet, etc.

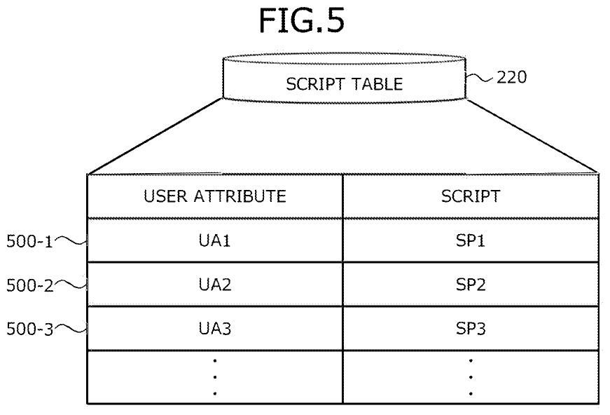

Here, the information processing apparatus 101 has a script table 220 and controls the conversation of the chatbot. For example, the information processing apparatus 101 is a server. Stored contents of the script table 220 are described hereinafter using FIG. 5.

The first information processing terminal 201 is a stationary computer that is used when a user converses with the chatbot. For example, the first information processing terminal 201 is a digital board installed in a highly public place and used by a large number of unspecified persons. The first information processing terminal 102 depicted in FIG. 1, for example, corresponds to the first information processing terminal 201.

The second information processing terminal 202 is a portable computer that is used when a user converses with the chatbot. For example, the second information processing terminal 202 is a smartphone, a tablet PC, etc. of an individual. The second information processing terminal 103 depicted in FIG. 1, for example, corresponds to the second information processing terminal 202.

The operator terminal 203 is a computer used by an operator. The operator responds to a user when a conversation is switch from chatbot-support to human-support. For example, the operator may speak directly with the user, using a telephone function of the operator terminal 203. For example, the operator terminal 203 is a PC, a tablet PC, etc.

Here, while the first information processing terminal 201, the second information processing terminal 202, and the operator terminal 203 are each depicted as a single device, configuration is not limited hereto. For example, in the conversation control system 200, the first information processing terminal 201, the second information processing terminal 202, and the operator terminal 203 may each be included in plural.

An example of hardware configuration of the information processing apparatus 101 is described.

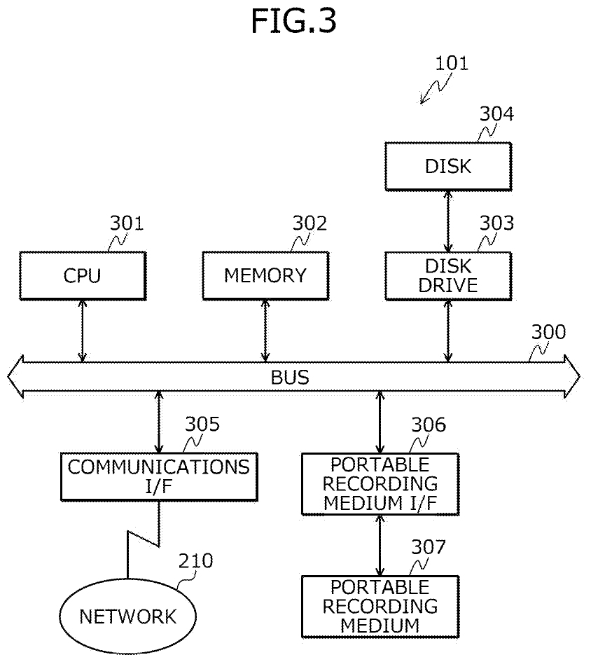

FIG. 3 is a block diagram of an example of a hardware configuration of the information processing apparatus 101. In FIG. 3, the information processing apparatus 101 has a central processing unit (CPU) 301, a memory 302, a disk drive 303, a disk 304, a communications interface (I/F) 305, a portable recording medium I/F 306, and a portable recording medium 307. Further, these components are connected to one another by a bus 300.

Here, the CPU 301 governs overall control of the information processing apparatus 101. The CPU 301 may have multiple cores. The memory 302, for example, includes a read only memory (ROM), a random access memory (RAM), and a flash ROM, etc. In particular, for example, the flash ROM stores therein programs such as an operating system (OS), the ROM stores therein application programs, and the RAM is used as a work area of the CPU 301. Programs stored in the memory 302 are loaded onto the CPU 301, whereby encoded processes are executed by the CPU 301.

The disk drive 303, under the control of the CPU 301, controls the reading and writing of data with respect to the disk 304. The disk 304 stores therein data written thereto under the control of the disk drive 303. The disk 304, for example, may be a magnetic disk, an optical disk, etc.

The communications I/F 305 is connected to the network 210 through a communications line and is connected to an external computer (for example, the first and the second information processing terminals 201, 202, the operator terminal 203 depicted in FIG. 2) through the network 210. Further, the communications I/F 305 administers an internal interface with the network 210 and controls the input and output of data from an external computer. As the communications I/F 305, for example, a modem, a LAN adapter, etc. may be adopted.

The portable recording medium I/F 306, under the control of the CPU 301, controls the reading and writing of data with respect to the portable recording medium 307. The portable recording medium 307 stores therein data written thereto under the control of the portable recording medium I/F 306. The portable recording medium 307, for example, is a compact disc (CD)-ROM, a digital versatile disk (DVD), a universal serial bus (USB) memory, etc.

The information processing apparatus 101, for example, may have a solid state drive (SSD), an input apparatus, a display, etc. in addition to the components described above. Further, of the components described above, the information processing apparatus 101, for example, may omit the disk drive 303, the disk 304, the portable recording medium I/F 306, and/or the portable recording medium 307.

An example of a hardware configuration of the first and the second information processing terminals 201, 202 is described. Herein, the first and the second information processing terminals 201, 202 are indicated as “the first information processing terminal 201, etc.”

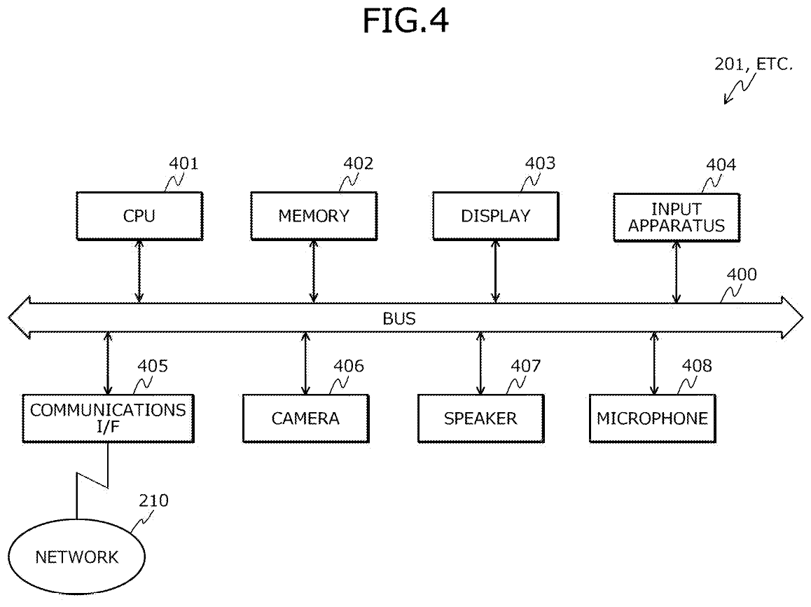

FIG. 4 is a block diagram of an example of a hardware configuration of the first information processing terminal 201, etc. In FIG. 4, the first information processing terminal 201, etc. each has a CPU 401, a memory 402, a display 403, an input apparatus 404, a communications I/F 405, a camera 406, a speaker 407, and a microphone 408. Further, these components are connected to one another by a bus 400.

Here, the CPU 401 governs overall control of the first information processing terminal 201, etc. The CPU 401 may have multiple cores. The memory 402, for example, is a storage having a ROM, a RAM, and a flash ROM. In particular, for example, the flash ROM and the ROM store therein various types of programs and the RAM is used as a work area of the CPU 401. Programs stored in the memory 402 are loaded onto the CPU 401, whereby encoded processes are executed by the CPU 401.

The display 403 is a display apparatus that displays a cursor, icons, or a toolbox in addition to documents, images, functional information, etc. As the display 403, for example, a liquid crystal display, an organic electroluminescence (EL) display, etc. may be adopted.

The input apparatus 404 has keys for inputting text, numerals, various types of instructions, etc., and inputs data. The input apparatus 404 may be a touch panel type input pad, a numeric keypad, a keyboard, a mouse, etc.

The communications I/F 405 is connected to the network 210 through a communications line and is connected to an external computer (for example, the information processing apparatus 101, the operator terminal 203) through the network 210. Further, the communications I/F 405 administers an internal interface with the network 210 and controls the input and output of data from an external apparatus.

The camera 406 is a photographing apparatus that captures images (still pictures or video) and outputs image data. The camera 406, for example, is provided at a position enabling photographing of a person looking at the display 403, a companion thereof, etc. The speaker 407 converts an electrical signal into sound and outputs the sound. The microphone 408 receives sounds and converts the sounds into an electrical signal.

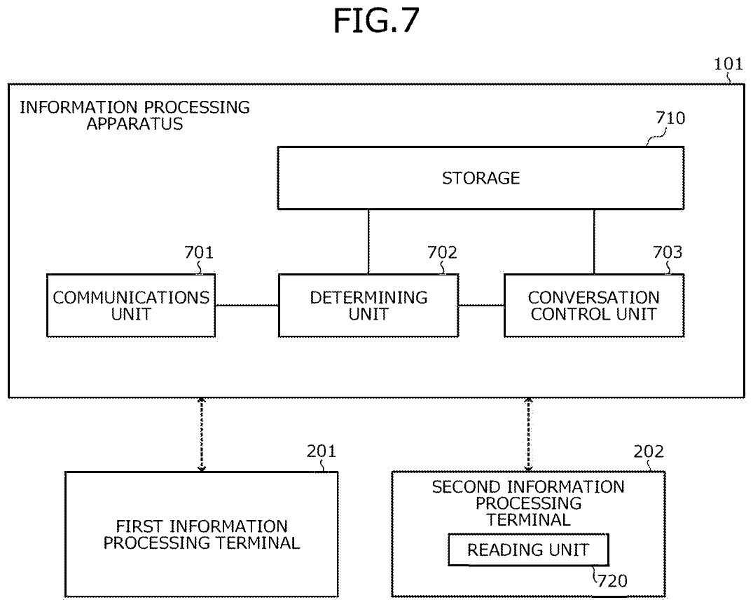

The first information processing terminal 201, etc. may have, for example, a hard disk drive (HDD), a SSD, a near field communications I/F , a portable recording medium I/F, a Global Positioning System (GPS) unit, etc. in addition to the components described above. However, in addition to the components described above, the second information processing terminal 202 has a reading unit 720 (refer to FIG. 7 described hereinafter) configured to read transfer guidance output from the first information processing terminal 201. Further, the operator terminal 203 depicted in FIG. 2 may also be realized by a hardware configuration similar to that of the first information processing terminal 201, etc.

Stored contents of the script table 220 of the information processing apparatus 101 are described. The script table 220, for example, is realized by a storage apparatus such as the memory 302, the disk 304 depicted in FIG. 3.

FIG. 5 is a diagram of an example of stored contents of the script table 220. In FIG. 5, the script table 220 has fields for user attributes and scripts, and by setting information into the fields, script management information (for example, script management information 500-1 to 500-3) is stored as records.

Here, user attributes represent characteristics of users and, for example, are classifications that are combinations of age, gender, language, clothing (article worn), location information, meteorological information, etc. User attributes may be, for example, “twentiesxfemale”, “thirtiesxmale”, “twentiesxfemalexwith children”, “twentiesxfemalexlanguage (English)”, “twentiesxfemalexcouple”, “twentiesxfemalexweather (rain)”, “twentiesxfemalextemperature (at least 25 degrees C)”, “twentiesxmalexlocation (Akihabara)”, “twentiesxclothing (glasses)”, etc. User attributes, for example, may be set as “ALL” to target all users.

A script is information (scenario) defining the flow of the conversation performed by the chatbot and is prepared associated with the user attributes. However, in FIG. 5, only script IDs (for example, SP1, SP2, SP3, . . . ) identifying the scripts are depicted. For example, the script management information 500-1 indicates that a script SP1 corresponds to a user attribute UA1.

A specific example of a script defining a flow of a conversation performed by the chatbot is described. Here, the script SP1 that corresponds to the user attribute UA1 is described as an example.

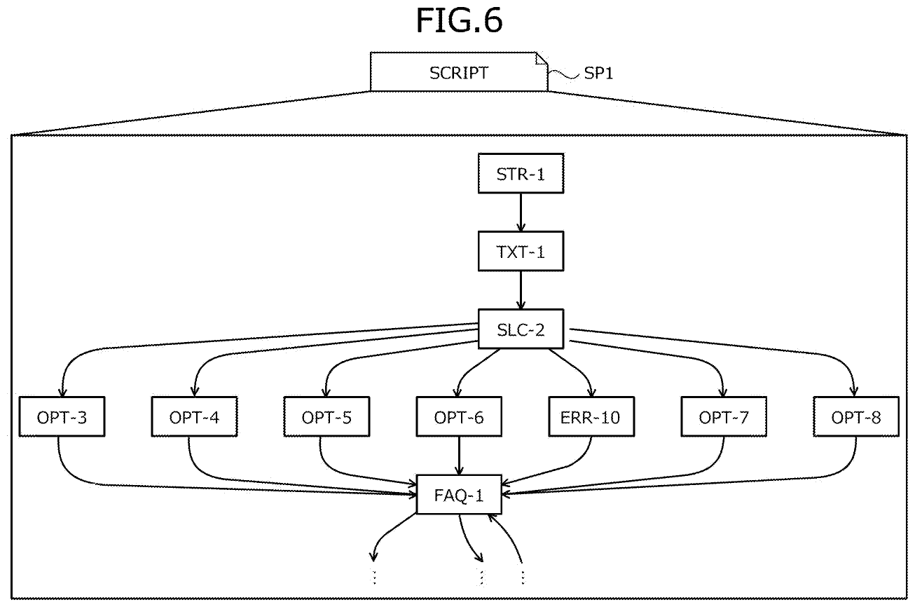

FIG. 6 is a diagram of a specific example of a script. In FIG. 6, the script SP1 is information (a scenario) defining a flow of a conversation performed by the chatbot. However, in FIG. 6, a portion of the script SP1 is excerpted and displayed. In particular, for example, the script SP1 is information defining a flow of the talk process of a chat.

The talk process is a process for realizing operation (behavior) of the chatbot. For example, the talk process includes the process of speaking, the process of displaying options, the process of selecting an option according to user operation, the process of performing procedures according to the selected option, the process of ending the talk process, etc.

In the script SP1, for example, STR-1 indicates the start of the talk process. TXT-1 indicates the process of speaking a message “Hello. I'm a chatbot. What is your question?”. SLC-2 indicates the process of displaying options OPT-3 to OPT-8. For example, OPT-3 indicates an option “Regarding family register/certificates”. FAQ-1 is a process of searching for and displaying FAQs corresponding to an option. ERR-10 indicates an error process.

FIG. 7 is a block diagram of an example of a functional configuration of the information processing apparatus 101. In FIG. 7, the information processing apparatus 101 includes a communications unit 701, a determining unit 702, a conversation control unit 703, and a storage 710. In particular, for example, the communications unit 701 to the conversation control unit 703 are realized by executing a program stored in a storage apparatus such as the memory 302, the disk 304, the portable recording medium 307 depicted in FIG. 3, etc. on the CPU 301 or through the communications I/F 305. Process results of the functional units, for example, are stored to a storage apparatus such as the memory 302, the disk 304, etc. The storage 710, for example, is realized by a storage apparatus such as the memory 302, the disk 304, etc. In particular, for example, the storage 710 stores therein the script table 220 depicted in FIG. 5.

The communications unit 701 receives a start instruction for a chat from the first information processing terminal 201 and receives first identification information corresponding to the first information processing terminal 201. Here, the first identification information is information used for determining a script to be applied to a conversation performed by the chatbot via the first information processing terminal 201 and is information identifying a state or characteristic of the user of the first information processing terminal 201.

For example, the first identification information includes attribute information of the user obtained by the first information processing terminal 201. The attribute information of the user is information representing characteristics of the user. For example, the attribute information of the user is information that identifies the age, gender, language, clothing, presence/absence of a companion, etc. of the user. The attribute information of the user may include location information that indicates the installation location of the first information processing terminal 201. The installation location of the first information processing terminal 201 corresponds to the current location of the user. Further, the attribute information of the user may include meteorological information (temperature, humidity, weather, etc.) for the installation location of the first information processing terminal 201. The meteorological information for the installation location of the first information processing terminal 201 corresponds to meteorological information for the current location of the user.

In particular, for example, the first information processing terminal 201 extracts the attribute information of the user, when detecting the user by the camera 406 thereof (refer to FIG. 4) or in response to an input operation of the user using the input apparatus 404 (refer to FIG. 4). Subsequently, the first information processing terminal 201 transmits a start instruction for a chat and the first identification information that includes the extracted attribute information of the user to the information processing apparatus 101.

More specifically, for example, the first information processing terminal 201 may analyze image data (for example, video) obtained by the camera 406 thereof to extract attribute information such as the age, gender, clothing, presence/absence of a companion, etc. of the user. Here, the first information processing terminal 201 may extract characteristics (age, gender, etc.) of a companion as attribute information. Further, the first information processing terminal 201 may analyze sound data obtained by the microphone 408 thereof (refer to FIG. 4) to extract attribute information such as the gender, language, etc. of the user.

Further, the first information processing terminal 201 may obtain meteorological information such as the temperature, humidity, weather, etc. by a non-depicted environment sensor or by inquiry to an external server. Further, the first information processing terminal 201 may obtain, by a non-depicted GPS unit, location information that indicates the current location. Nonetheless, location information that indicates the installation location of the first information processing terminal 201 may be stored to the memory 402 of the first information processing terminal 201 in advance.

As a result, at the first information processing terminal 201, information indicating the age, gender, language, clothing, presence/absence of a companion of the user, location information, meteorological information, etc. may be obtained.

Any existing technique may be used to extract attribute information of the user from image data, sound data, etc. For example, the first information processing terminal 201 may extract attribute information such as the age, gender, clothing, language, presence/absence of a companion, etc. from a feature value an image and/or sound, by a technique based on machine learning such as deep learning.

Nonetheless, the first information processing terminal 201, for example, may receive input of the attribute information of the user by an input operation by the user using the input apparatus 404 (refer to FIG. 4). In this instance, the first information processing terminal 201 transmits the start instruction for a chat and the first identification information including the input attribute information of the user to the information processing apparatus 101.

Further, the communications unit 701 may receive image data obtained by the camera 406 of the first information processing terminal 201 and/or sound data obtained by the microphone 408, as the first identification information. In this instance, at the information processing apparatus 101, attribute information such as age, gender, clothing, language, etc. may be extracted from the received image data and/or sound data. In other words, configuration may be such that a process of analyzing image data and/or sound data is not performed at the first information processing terminal 201.

The determining unit 702 determines the first script to be applied to the conversation performed by the chatbot via the first information processing terminal 201, based on the received first identification information. In particular, for example, the determining unit 702 refers to the storage 710 storing therein scripts respectively corresponding to multiple user attributes and determines the first script based on the first identification information.

For example, the determining unit 702, in response to a start instruction for a chat, identifies user attributes based on the attribute information of the user included in the first identification information. Subsequently, the determining unit 702 refers to the script table 220 and determines a script that corresponds to the identified user attributes as the first script to be applied to the conversation performed by the chatbot via the first information processing terminal 201.

For example, the attribute information of the user is assumed to be “age ‘twenties’, gender ‘female’”. In this instance, the determining unit 702 identifies user attributes “twentiesxfemale” based on the attribute information of the user. Subsequently, the determining unit 702 refers to the script table 220 and determines a script that corresponds to the identified user attributes “twentiesxfemale” as the first script.

Further, the attribute information of the user is assumed to be “age ‘twenties’, gender ‘female’, companion ‘yes (child)’”. In this instance, the determining unit 702 identifies user attributes “twentiesxfemalexwith children”, based on the attribute information of the user. Subsequently, the determining unit 702 refers to the script table 220 and determines a script that corresponds to the identified user attributes “twentiesxfemalexwith children” as the first script.

Further, the attribute information of the user is assumed to be “age ‘thirties’, gender ‘male’, location information ‘Akihabara’”. In this instance, the determining unit 702 identifies user attributes “thirtiesxmalexAkihabara”, based on the attribute information of the user. Subsequently, the determining unit 702 refers to the script table 220 and determines a script that corresponds to the identified user attributes “thirtiesxmalexAkihabara” as the first script.

Further, the attribute information of the user is assumed to be “age ‘twenties’, gender ‘female’, meteorological information ‘rain’”. In this instance, the determining unit 702 identifies user attributes “twentiesxfemalexrain”, based on the attribute information of the user. Subsequently, the determining unit 702 refers to the script table 220 and determines a script that corresponds to the identified user attributes “twentiesxfemalexrain” as the first script.

Further, the attribute information of the user is assumed to be “age ‘thirties’, clothing ‘glasses’”. In this instance, the determining unit 702 identifies user attributes “thirtiesxglasses”, based on the attribute information of the user. Subsequently, the determining unit 702 refers to the script table 220 and determines a script that corresponds to the identified user attributes “thirtiesxglasses” as the first script.

In some instances, a script that corresponds to identified user attributes may not be in the script table 220. In these instances, the determining unit 702 may refer to the script table 220 and determine a script that corresponds to user attributes “ALL” as the first script. Further, the determining unit 702 may refer to the script table 220 and determine as script that corresponds to at least any one element of the user attributes as the first script.

For example, it is assumed that no script that corresponds to user attributes “twentiesxfemalexrain” is present. In this instance, the determining unit 702 may refer to the script table 220 and determine a script that corresponds to any of the user attributes “twentiesxfemale”, “twentiesxrain”, and “femalexrain” as the first script.

The conversation control unit 703 uses the determined first script and starts a first conversation performed by the chatbot via the first information processing terminal 201. In particular, for example, according to the first script, the conversation control unit 703, via the chatbot, speaks, displays options, searches for and displays FAQs corresponding to a selected option, etc.

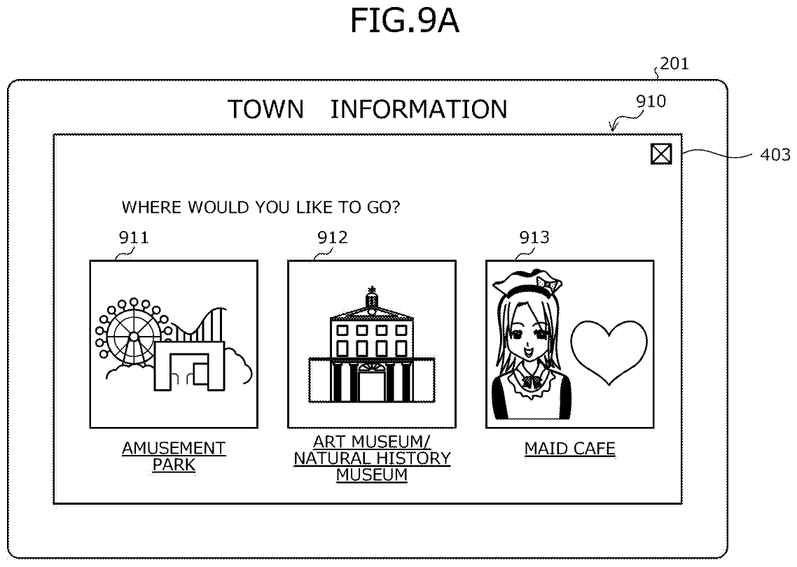

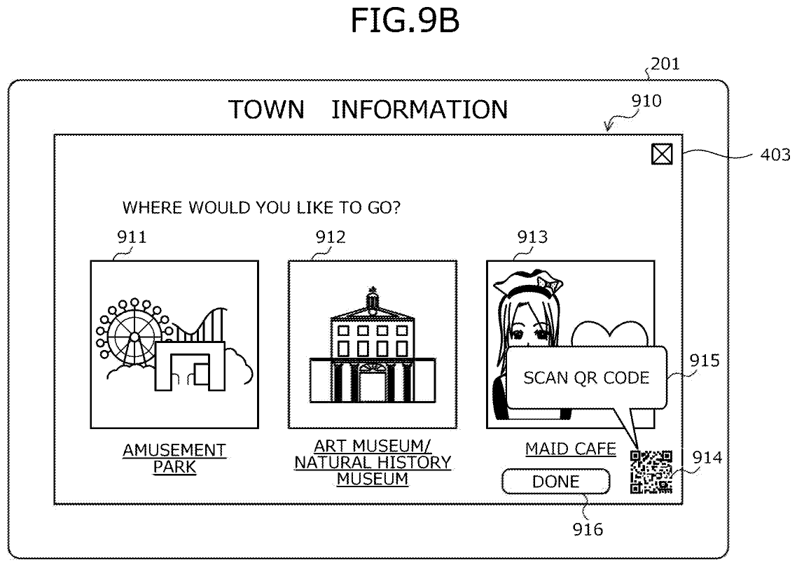

A conversation history (a so-called chatlog) between the user and the chatbot via the first information processing terminal 201, for example, is stored to a storage apparatus such as the memory 302, the disk 304, etc. Further, a screen example of a conversation screen displayed by the display 403 of the first information processing terminal 201 is described hereinafter using FIGS. 9A and 9B.

Further, the conversation control unit 703 causes the first information processing terminal 201 to output the transfer guidance for the first conversation, when conversation contents received from the first information processing terminal 201 satisfy a predetermined condition after the start of the first conversation. Here, the conversation contents, for example, include a selected option, an input message, etc. of the first conversation.

The transfer guidance prompts suspension of the conversation by the open chat and continuation of the conversation by a closed chat. In other words, the transfer guidance prompts suspension of the first conversation by the first information processing terminal 201 and continuation of the first conversation by the second information processing terminal 202 carried by the user.

Further, the transfer guidance is information enabling transfer information that indicates transfer from the first conversation to be obtained by reading the transfer guidance. The transfer information includes information identifying the first script, for example, a script ID. Further, the transfer information may include information identifying a point (transfer point) where the first conversation was suspended, a conversation history of the first conversation, etc.

The transfer point, for example, is information that identifies the talk process that suspended the first conversation and, for example, is indicated by a process name such as TXT-#, SLC-#, OPT-#, etc. The transfer point may be identified from the conversation history of the first conversation.

For example, transfer guidance is displayed by the display 403 of the first information processing terminal 201 as a QR code. Here, the conversation control unit 703 may cause the first information processing terminal 201 to output the QR code and a message such as “Please scan QR code”.

Further, the transfer guidance may be output from a non-depicted contactless integrated circuit (IC) tag of the first information processing terminal 201. Here, the conversation control unit 703, for example, may output a message “Touch here”, etc. by a contactless IC tag portion of the first information processing terminal 20. As the contactless IC tag, for example, a near field communication (NFC) tag may be used.

Further, the predetermined condition may be set arbitrarily. For example, the predetermined conditions may be a condition “contents of next inquiry relate to personal information”. Personal information includes names, dates of birth, telephone numbers, addresses, etc. Further, the predetermined condition may be “contents of next inquiry relates to a shop or service”. The shop or service may be a specified shop or service. Information that indicates to what contents of an inquiry is related (personal information, a shop, service, etc.), for example, is described in the first script.

In particular, for example, based on the first script, the conversation control unit 703 analyzes the conversation contents received from the first information processing terminal 201 and judges whether the conversation contents satisfy a predetermined condition. The conversation control unit 703, when judging that a predetermined condition is satisfied, causes the first information processing terminal 201 to output the transfer guidance for the first conversation.

However, talk process that is to output the transfer guidance for the first conversation may be preset in the first script. In other words, output of the transfer guidance may be preset to be at the time when a predetermined condition is satisfied in the flow of the first conversation.

The second information processing terminal 202, by the reading unit 720, reads the transfer guidance for the first conversation and output from the first information processing terminal 201 and thereby, obtains transfer information that indicates transfer from the first conversation. In particular, for example, the second information processing terminal 202, by the reading unit 720, reads a QR code displayed by the display 403 of the first information processing terminal 201 and thereby, obtains the transfer information. Further, the second information processing terminal 202, by the reading unit 720, may receive the transfer guidance output from the contactless IC tag of the first information processing terminal 201 and thereby, obtain the transfer information.

Further, the second information processing terminal 202 may obtain the transfer information and identification information of the user obtained by the first information processing terminal 201. In particular, for example, the second information processing terminal 202, by the reading unit 720, may read the transfer guidance that is for the first conversation and output from the first information processing terminal 201 and thereby, the second information processing terminal 202 may obtain the transfer information and the identification information of the user.

Further, the second information processing terminal 202 may communicate with the first information processing terminal 20, by near field communication, to thereby receive the identification information of the user. Further, the second information processing terminal 202, for example, may receive input of the attribute information of the user by an input operation by the user using the input apparatus 404 of the second information processing terminal 202. What type of attribute information is input, for example, may be determined in advance.

The second information processing terminal 202 transmits, to the information processing apparatus 101, transfer information obtained in response to obtaining transfer information that indicates transfer from the first conversation. Here, the second information processing terminal 202 transmits, to the information processing apparatus 101, the transfer information and second identification information corresponding to the second information processing terminal 202.

Here, the second identification information is information used for determining a script to be applied to the conversation performed by the chatbot via the second information processing terminal 202. For example, the second identification information is information identifying a state or characteristic of the user of the second information processing terminal 202. In particular, for example, the second identification information may include the attribute information of the user obtained by the second information processing terminal 202.

At the second information processing terminal 202, the attribute information of the user, for example, is obtained with the transfer information from the first information processing terminal 201. However, location information, meteorological information, etc. included in the attribute information of the user may be again obtained from location information indicating the current location of the second information processing terminal 202, meteorological information for the current location of the second information processing terminal 202, etc.

Further, at the second information processing terminal 202, image data obtained by the camera 406 of the second information processing terminal 202, sound data obtained by the microphone 408 of the second information processing terminal 202 (refer to FIG. 4), etc. may be analyzed to obtain the attribute information of the user. In this instance, the second information processing terminal 202 need not obtain the attribute information of the user obtained by the first information processing terminal 201.

Further, the second information processing terminal 202 may transmit the transfer information or may ask the user for permission to transmit the transfer information. In this instance, the second information processing terminal 202, when obtaining transmission permission, transmits the transfer information and the second identification information that corresponds to the second information processing terminal 202, to the information processing apparatus 101.

The communications unit 701 receives, from the second information processing terminal 202, the transfer information that indicates transfer from the first conversation. Further, the communications unit 701 may receive the transfer information and the second identification information that corresponds to the second information processing terminal 202. The second identification information, for example, includes the attribute information of the user obtained by the second information processing terminal 202.

The determining unit 702 determines the second script that is to be applied to the conversation performed by the chatbot via the second information processing terminal 202, based on the received transfer information. In particular, for example, the determining unit 702 refers to the storage 710 that stores therein scripts associated with transfer points of the first script and defining the flow of the conversation performed by the chatbot, following the first conversation, and the determining unit 702 determines the second script, based on the transfer information.

Further, the determining unit 702 may determine the second script, based on the received transfer information and second identification information. In particular, for example, the determining unit 702 may refer to the storage 710 that stores therein scripts that are associated with transfer points of the first script and each user attribute and that define the flow of the conversation performed by the chatbot following the first conversation, and the determining unit 702 may determine the second script, based on the transfer information and the second identification information.

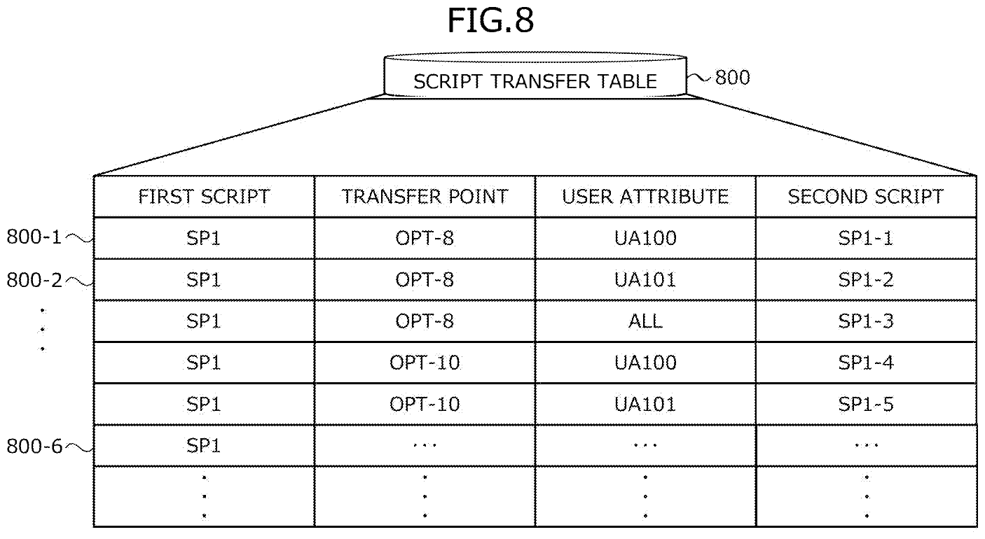

For example, the determining unit 702 identifies the user attributes, based on the attribute information of the user included in the second identification information. Subsequently, the determining unit 702, refers to a script transfer table 800 such as that depicted in FIG. 8 and determines the second script, based on the identified user attributes and transfer information.

Stored contents of the script transfer table 800 are described. The script transfer table 800, for example, is realized by a storage apparatus such as the memory 302, the disk 304 depicted in FIG. 3, etc.

FIG. 8 is a diagram of an example of stored contents of the script transfer table 800. In FIG. 8 are fields for first scripts, transfer points, user attributes, and second scripts and by setting information in the fields, script transfer information (for example, script transfer information 800-1 to 800-6) is stored as records.

Here, the first scripts are transfer-origin script. The user attributes represent characteristics of users categorized by combinations of, for example, age, gender, language, clothing, location information, meteorological information, etc. The second scripts are transfer-destination scripts prepared associated with the user attributes.

For example, the attribute information of the user is assumed to be “age ‘twenties’, gender ‘female’”. In this instance, the determining unit 702 identifies user attributes “twentiesxfemale”, based on the attribute information of the user. Further, the transfer information is assumed to include the script ID “SP1” identifying the first script and the transfer point “OPT-8”. In this instance, the determining unit 702 refers to the script transfer table 800 and determines a script that corresponds to the first script “S1”, the transfer point “OPT-8”, and user attributes “twentiesxfemale”, as the second script.

Further, the attribute information of the user is assumed to be “age ‘thirties’, gender ‘male’, location information ‘Akihabara’”. In this instance, the determining unit 702 identifies user attributes “thirtiesxmalexAkihabara”, based on the attribute information of the user. Further, the transfer information is assumed to include the script ID “SP1” identifying the first script and a transfer point “OPT-10”. In this instance, the determining unit 702 refers to the script transfer table 800 and determines a script that corresponds to the first script “SP1”, the transfer point “OPT-10”, and user attributes “thirtiesxmalexAkihabara”, as the second script.

In some instances no script corresponding to the identified user attributes is present in the script transfer table 800. In these instances, the determining unit 702 may refer to the script transfer table 800 and determine a script that corresponds to the first script, the transfer point, and user attributes “ALL”, as the second script.

Further, the determining unit 702 may refer to the script transfer table 800 and determine a script that corresponds to the first script, the transfer point, and at least any one element of the user attributes, as the second script.

For example, it is assumed that no script that corresponds to the first script “SP1”, the transfer point “OPT-8”, and user attributes “twentiesxfemale” is present. In this instance, the determining unit 702 may refer to the script table 220 and determine a script that corresponds to the first script “SP1”, the transfer point “OPT-8”, and user attribute “twenties”, as the second script. Alternatively, the determining unit 702 may determine a script that corresponds to the first script “SP1”, the transfer point “OPT-8”, and user attribute “female”, as the second script.

The conversation control unit 703 uses the determined second script and starts a second conversation performed by the chatbot via the second information processing terminal 202, following the first conversation. In particular, for example, according to the second script, the conversation control unit 703, via the chatbot, speaks, displays options, searches for and displays FAQs corresponding to a selected option, etc.

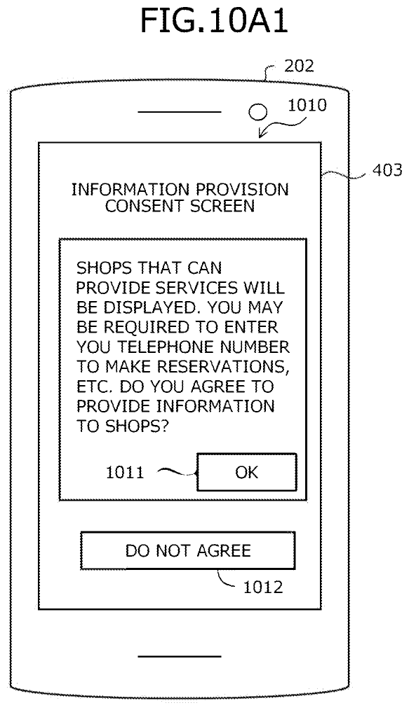

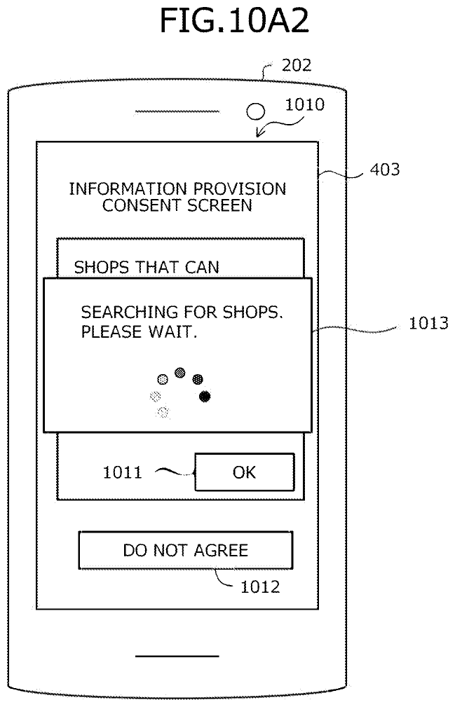

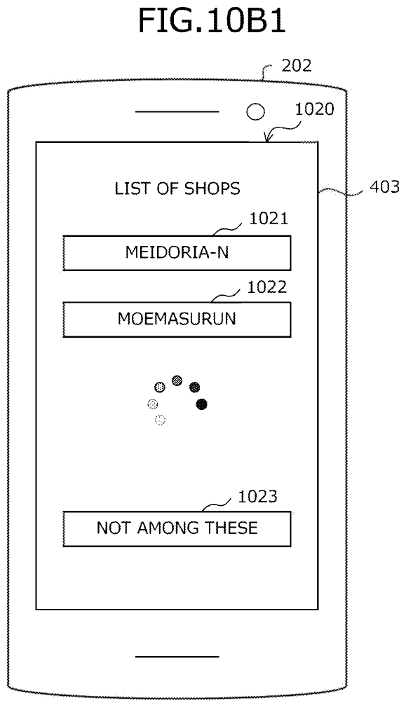

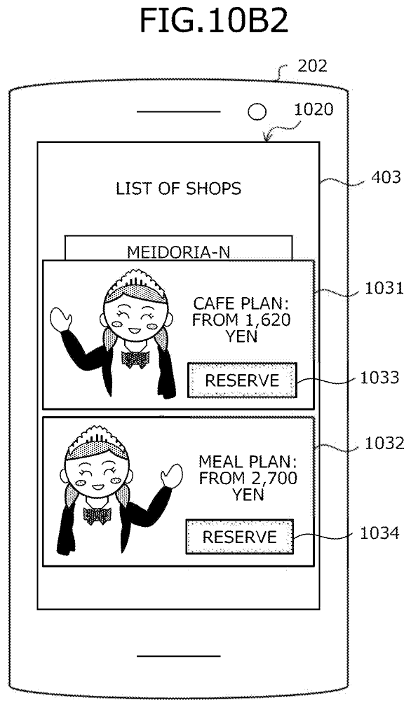

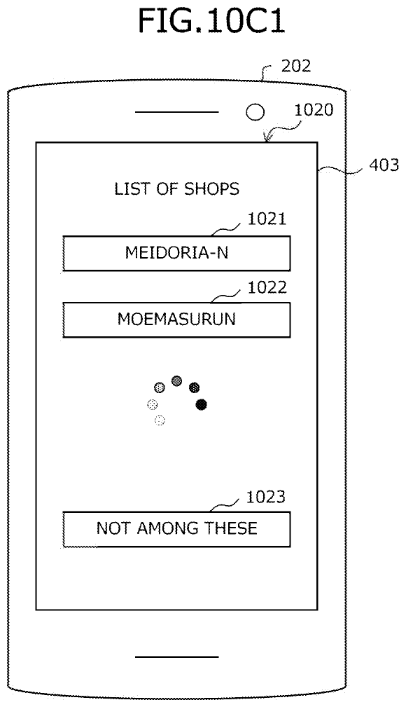

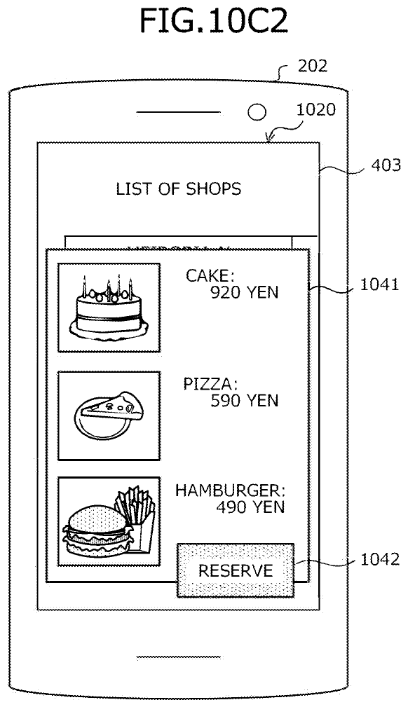

A conversation history (a so-called chatlog) between the user and the chatbot via the second information processing terminal 202, for example, is stored to a storage apparatus such as the memory 302, the disk 304, etc. Further, a screen example of a conversation screen displayed by the display 403 of the second information processing terminal 202 is described hereinafter using FIGS. 10A1, 10A2, 10B1, 10B2, 10C1, and 10C2.

The scripts may include description of a process of switching a conversation from chatbot-support to human-support when a specific condition is satisfied, based on the conversation history of the chatbot. In this instance, after a conversation performed by the chatbot is started according to the first script, the conversation control unit 703, for example, switches the conversation from chatbot-support to human-support, when a specific condition is satisfied, based on the conversation history.

For example, the conversation control unit 703 may judge that a specific condition is satisfied when a specific keyword is input. The specific keyword may be arbitrarily set. For example, the specific keyword may be “Send out the person in charge”, “Send out your supervisor”, etc. or may be a business keyword such as “luxurious French dining”, “resort”, etc.

Further, the conversation control unit 703, for example, may judge that a specific condition is satisfied when a specific option is selected multiple times. A specific option, for example, is an option that is selected such as “Not among these”, “No”, etc., when desired information is not obtained. Further, the conversation control unit 703, when determining that a specific condition is satisfied, connects the first information processing terminal 201 and the operator terminal 203, and switches the conversation from chatbot-support to human-support by an operator.

A screen example of a conversation screen displayed by the display 403 of the first information processing terminal 201 is described using FIGS. 9A and 9B. Herein, the first information processing terminal 201 is assumed to be a digital board installed at a transit station, an airport, in a town, etc.

FIGS. 9A and 9B are diagrams of screen examples of conversation screens displayed by the first information processing terminal 201. In the example depicted in FIG. 9A, the attribute information of the user is assumed to be “age ‘thirties’, gender ‘male’, location information ‘Akihabara’”. In this instance, for example, a first script corresponding to user attributes “thirtiesxmalexAkihabara” is used to start the first conversation performed by the chatbot via the first information processing terminal 201.

As a result, the user may converse with the chatbot, according to a script that reaches a FAQ frequently selected by users having similar characteristics to the user. In the description hereinafter, a first script corresponding to user attributes “thirtiesxmalexAkihabara” may be indicated as “first script SPx”.

For example, a conversation screen 910 is one example of a conversation screen displayed by the display 403 of the first information processing terminal 201, when a conversation performed by the chatbot is started using the first script SPx that corresponds to user attributes “thirtiesxmalexAkihabara”. In the conversation screen 910, selection buttons 911 to 913 are displayed.

For example, in the conversation screen 910, any one of the selection buttons 911 to 913 is selected by an input operation by the user using the input apparatus 404 (refer to FIG. 4), whereby the user may proceed to a subsequent conversation. The selection buttons 911 to 913 are for selecting an answer to a question “Where would you like to go?” from the chatbot.

When the user wants to go to an “amusement park”, the user selects the selection button 911. Further, when the user wants to go to an “art museum/natural history museum”, the user selects the selection button 912. Further, when the user wants to go to a “maid cafe”, the user selects the selection button 913. While not depicted, in the conversation screen 910, for example, a selection button such as “not among these”, etc. to be selected when a desired option is not present, a box in which a message is entered, etc. may be included.

Here, the selection button 913 is assumed to be selected. Further, a selection of the selection button 913 is assumed to be an instance of conversation contents that satisfy a predetermined condition because contents of next inquiry relate to personal information. In this instance, as depicted in FIG. 9B, a QR code 914 is displayed by the display 403 of the first information processing terminal 201.

In particular, for example, the conversation control unit 703 displays the QR code 914 and a message 915 on the display 403 of the first information processing terminal 201. The QR code 914 is transfer guidance for the first conversation. The message 915 prompts reading of the QR code 914.

In the conversation screen 910, when reading of the QR code 914 by the second information processing terminal 202 is finished and a done button 916 is selected, the QR code 914 disappears, and the screen returns to the previous screen (refer to FIG. 9A). Further, at the second information processing terminal 202, when reading of the QR code 914 is finished, transfer information that indicates transfer from the first conversation and the identification information of the user obtained by the first information processing terminal 201 are obtained.

Subsequently, the transfer information and the second identification information corresponding to the second information processing terminal 202 are transmitted from the second information processing terminal 202 to the information processing apparatus 101. As a result, a conversation screen 1010 like that depicted in FIG. 10A1 is displayed by the display 403 of the second information processing terminal 202.

A screen example of a conversation screen displayed by the display 403 of the second information processing terminal 202 is described using FIGS. 10A1, 10A2, 10B1, 10B2, 10C1, and 10C2.

FIGS. 10A1, 10A2, 10B1, 10B2, 10C1, and 10C2 are diagrams of screen examples of conversation screens of the second information processing terminal 202. In the example in FIGS. 10A1 and 10A2, the transfer point from the first conversation performed using the first script SPx is assumed to be “OPT-y”. In this instance, for example, a second script corresponding to the first script “SPx”, the transfer point “OPT-y” and user attributes “thirtiesxmalexAkihabara” is used to start a second conversation performed by the chatbot via the second information processing terminal 202, following the first conversation.

As a result, the user may continue the conversation performed by an open chat in the first information processing terminal 201, by a closed chat in the second information processing terminal 202. In the description hereinafter, the second script corresponding to the first script “SPx”, the transfer point “OPT-y”, and user attributes “thirtiesxmalexAkihabara” may be indicated as “second script SPx-y”.

For example, the conversation screen 1010 is one example of a conversation screen displayed by the display 403 of the second information processing terminal 202, when a conversation performed by the chatbot is started using the second script SPx-y. The conversation screen 1010 is one example of an operation screen asking for consent to provide personal information such as a telephone number to a shop.

In the conversation screen 1010, when a button 1011 is selected by an input operation by the user using the input apparatus 404 (refer to FIG. 4), a message 1013 is displayed and a search for shops providing the service is performed. The message 1013 gives notification that a search for shops providing a certain service is being performed.

When a shop providing the service is found, a conversation screen 1020 such as that depicted in FIGS. 10B1 and 10B2 or FIGS. 10C1 and 10C2 is displayed. In the conversation screen 1010, a button 1012 is selected, whereby the conversation (second conversation) with the chatbot via the second information processing terminal 202 may be terminated.

In FIGS. 10B1, 10B2, 10C1, and 10C2, the conversation screen 1020 is one example of an operation screen showing a list of shops providing the service. In the conversation screen 1020, when either of selection buttons 1021, 1022 is selected by an input operation by the user, information related to the shop may be displayed.

For example, in the conversation screen 1020, when the selection button 1021 is selected, as depicted in FIGS. 10B1 and 10B2, menu information 1031, 1032 of a shop “meidoria-n” is displayed as a popup screen. By selecting any one of reservation buttons 1033, 1034 for the menu information 1031, 1032, the user may specify and reserve a corresponding plan.

Further, in the conversation screen 1020, when the selection button 1022 is selected, as depicted in FIGS. 10C1 and 10C2, menu information 1041 for a shop “moemasurun” is displayed as a popup screen. By selecting a reservation button 1042 for the menu information 1041, the user may reserve a table.

In this manner, the conversation with the chatbot is transferred from an open chat to a closed chat at the time when an inquiry related to personal information is to occur, thereby enabling the conversation with the chatbot to be performed safely and securely. Further, operations that take time such as shop selection may be performed by a closed chat, whereby situations of prolonged use of the first information processing terminal 201 by a single individual may be prevented.

In the conversation screen 1020, when the selection button 1023 is selected by an input operation by the user, the conversation (second conversation) with the chatbot via the second information processing terminal 202 may be terminated.

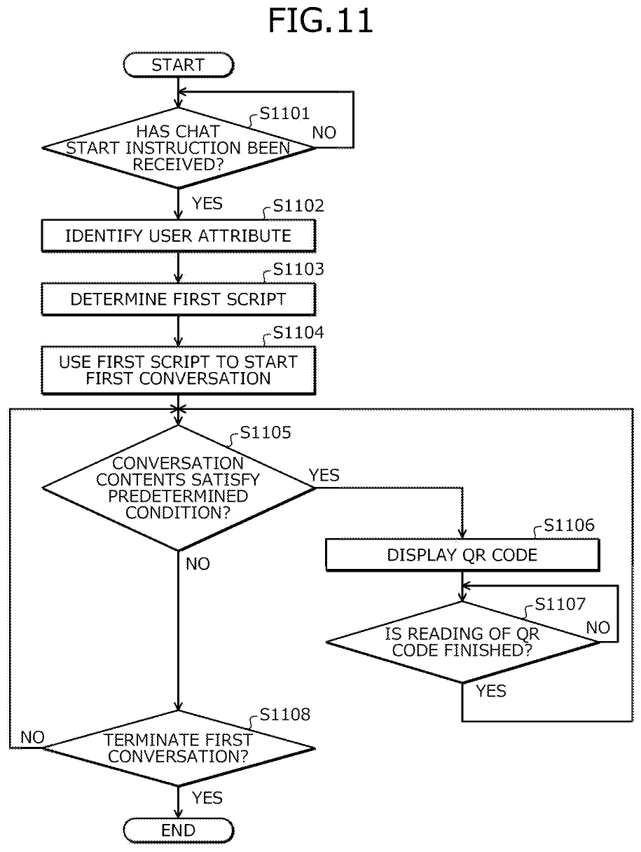

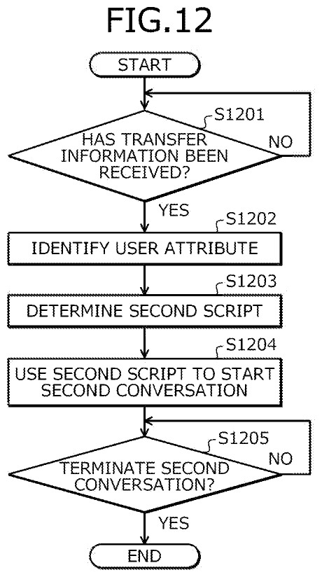

A procedure of a conversation control process of the information processing apparatus 101 is described using FIGS. 11 and 12. First, a procedure of a first conversation control process of controlling a conversation performed by the chatbot via the first information processing terminal 201 is described using FIG. 11.

FIG. 11 is a flowchart of an example of a procedure of the first conversation control process of the information processing apparatus 101. In the flowchart in FIG. 11, first, the information processing apparatus 101 receives a start instruction for a chat from the first information processing terminal 201 and judges whether first identification information corresponding to the first information processing terminal 201 has been received (step S1101).

Here, the information processing apparatus 101 waits to receive a start instruction for a chat and first identification information (step S1101: NO). When the information processing apparatus 101 receives a start instruction for a chat and first identification information (step S1101: YES), the information processing apparatus 101 identifies a user attribute based on the received first identification information (step S1102).

Next, the information processing apparatus 101 refers to the script table 220 and determines a script corresponding to the identified user attribute, as the first script applied to the conversation performed by the chatbot via the first information processing terminal 201 (step S1103). Subsequently, the information processing apparatus 101 uses the determined first script and starts the first conversation performed by the chatbot via the first information processing terminal 201 (step S1104).

Next, the information processing apparatus 101 judges whether conversation contents received from the first information processing terminal 201 satisfy a predetermined condition (step S1105). For example, the information processing apparatus 101 judges that a predetermined condition is satisfied, when the contents of the next inquiry of the conversation contents to be received from the first information processing terminal 201 relate personal information.

Here, when a predetermined condition is satisfied (step S1105: YES), the information processing apparatus 101 displays transfer guidance for the first conversation as a QR code on the display 403 of the first information processing terminal 201 (step S1106). Subsequently, the information processing apparatus 101 judges whether reading of the QR code is finished (step S1107).

Here, the information processing apparatus 101 waits for the reading of the QR code to be completed (step S1107: NO). When the reading of the QR code is finished (step S1107: YES), the information processing apparatus 101 returns to step S1105.

Further, at step S1105, when a predetermined condition is not satisfied (step S1105: NO), the information processing apparatus 101 judges whether to terminate the first conversation performed by the chatbot via the first information processing terminal 201 (step S1108). The first conversation performed by the chatbot, for example, is terminated according to the first script or according to a forced termination operation by the user.

Here, when the first conversation performed by the chatbot is not to be terminated (step S1108: NO), the information processing apparatus 101 returns to step S1105. On the other hand, when the first conversation performed by the chatbot is to be terminated (step S1108: YES), the information processing apparatus 101 terminates a series of operations according to the flowchart.

As a result, according to characteristics (for example, age, gender, etc.) of the user using the first information processing terminal 201, the flow of the conversation performed by the chatbot via the first information processing terminal 201 may be controlled. Further, suspension of the conversation by the open chat and continuation of the conversation by a closed chat may be prompted at the time when an inquiry related to personal information is to occur.

At step S1107, when the reading of the QR code is finished, the information processing apparatus 101 may terminate the series of operations according to the flowchart.

Next, a procedure of a second conversation control process of controlling the conversation performed by the chatbot via the second information processing terminal 202 is described using FIG. 12.

FIG. 12 is a flowchart of an example of a procedure of the second conversation control process of the information processing apparatus 101. In the flowchart in FIG. 12, first, the information processing apparatus 101 judges whether transfer information that indicates transfer from the first conversation, and the second identification information corresponding to the second information processing terminal 202 have been received from the second information processing terminal 202 (step S1201).

Here, the information processing apparatus 101 waits to receive the transfer information and the second identification information (step S1201: NO). When the transfer information and the second identification information have been received (step S1201: YES), the information processing apparatus 101 identifies user attributes, based on the attribute information of the user included in the received second identification information (step S1202).

Next, the information processing apparatus 101 refers to the script transfer table 800 and based on the identified user attributes and the transfer information, determines a second script to be applied to the conversation performed by the chatbot via the second information processing terminal 202 (step S1203). Subsequently, the information processing apparatus 101 uses the determined second script and starts the second conversation performed by the chatbot via the second information processing terminal 202, following the first conversation (step S1204).

Next, the information processing apparatus 101 judges whether to terminate the second conversation performed by the chatbot via the second information processing terminal 202 (step S1205). The second conversation performed by the chatbot, for example, is terminated according to the second script or according to a forced termination operation by the user.

Here, the information processing apparatus 101 waits for termination of the second conversation performed by the chatbot (step S1205: NO). When the second conversation performed by the chatbot is terminated (step S1205: YES), the information processing apparatus 101 terminates a series of operations according to the flowchart.

As a result, the conversation by the open chat suspended at the time when an inquiry related to personal information occurs may be transferred to a closed chat.

As described above, the information processing apparatus 101 according to the embodiment enables reception of a start instruction for a chat and reception of the first identification information corresponding to the first information processing terminal 201, from the first information processing terminal 201, and enables the start of the first conversation performed by the chatbot, using the first script that is determined based on the received first identification information, the first conversation being performed via the first information processing terminal 201. The first identification information, for example, includes the attribute information of the user obtained by the first information processing terminal 201.

As a result, for example, according to a state or characteristics (for example, age, gender, location, etc.) of the user using the first information processing terminal 201, the flow of the first conversation performed by the chatbot via the first information processing terminal 201 may be changed dynamically.

Further, the information processing apparatus 101 enables the start of the second conversation with the chatbot, using the second script determined based on transfer information, in an instance in which transfer information that indicates transfer of the first conversation is received from the second information processing terminal 202, the second conversation being performed via the second information processing terminal 202, following the first conversation.

As a result, transfer of the conversation from an open chat to a closed chat is possible. Therefore, situations in which the first information processing terminal 102 that is assumed to be installed in a highly public place for use by a large number of unspecified persons, is used for a prolonged period by a single individual may be prevented, thereby facilitating smooth provision of services using the chatbot.

Further, the information processing apparatus 101 enables determination of the second script, based on transfer information and the second identification information, in an instance in which the transfer information and the second identification information of the second information processing terminal 202 are received from the second information processing terminal 202. The second identification information, for example, includes the attribute information of the user obtained by the second information processing terminal 202.

As a result, for example, according to a state or characteristics (for example, age, gender, location, etc.) of the user using the first information processing terminal 201, the flow of the first conversation performed by the chatbot via the first information processing terminal 201 may be changed dynamically.

Further, the information processing apparatus 101 enables causing the first information processing terminal 201 to output transfer guidance for the first conversation, in an instance in which the conversation contents received from the first information processing terminal 201 satisfy a predetermined condition after the start of the first conversation.

As a result, suspension of the conversation by the open chat and continuation of the conversation by a closed chat may be prompted. Further, the second information processing terminal 202 may obtain the transfer information that indicates transfer from the first conversation, by reading the transfer guidance output from the first information processing terminal 201.

Further, the information processing apparatus 101 enables display of the transfer guidance as a QR code by the first information processing terminal 201

As a result, by a simple operation of reading the QR code by the second information processing terminal 202, the second information processing terminal 202 may be caused to obtain the transfer information that indicates transfer from the first conversation.

Further, the information processing apparatus 101 enables causing the first information processing terminal 201 to output the transfer guidance in an instance in which, from the conversation contents received from the first information processing terminal 201, it is judged that the contents of next inquiry relate to personal information.

As a result, the conversation with the chatbot is transferred from an open chat to a closed chat at the time when input of personal information, etc. is to occur, whereby the personal information may be prevented from being seen by others or leaked.

Further, the information processing apparatus 101 enables causing the first information processing terminal 201 to output the transfer guidance in an instance in which, from the conversation contents received from the first information processing terminal 201, it is judged that the contents of next inquiry relate to a shop or service.

As a result, the conversation with the chatbot is transferred from an open chat to a closed chat at the time when shop selection, etc. is to occur, whereby operations that take time such as selecting a shop may be performed by a closed chat.

The conversation control method described in the present embodiment may be implemented by executing a prepared program on a computer such as a personal computer and a workstation. This conversation control program is stored on a non-transitory, computer-readable recording medium such as a hard disk, a flexible disk, a CD-ROM, a DVD, a USB memory, etc., read out from the computer-readable medium, and executed by the computer. The conversation control program may be distributed through a network such as the Internet.

The information processing apparatus 101 described in the present embodiment may be realized by an application specific integrated circuit (ASIC) such as a standard cell or a structured ASIC, or a programmable logic device (PLD) such as a field-programmable gate array (FPGA).

According to one aspect of the present invention, an effect is achieved in that a chat may be transferred between different apparatuses.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium having stored therein a program for causing a computer to execute a process, the process comprising:
receiving, from a first information processing terminal, a start instruction for a chat and identification information corresponding to the first information processing terminal;
determining, based on the received identification information, a first script to be applied to a conversation performed by a chatbot via the first information processing terminal, and starting a first conversation performed by the chatbot via the first information processing terminal, using the determined first script; and
when receiving, from a second information processing terminal, transfer information that indicates transfer from the first conversation, determining, based on the received transfer information, a second script to be applied to the conversation performed by the chatbot via the second information processing terminal, and starting a second conversation performed by the chatbot, using the determined second script, the second conversation being performed via the second information processing terminal, following the first conversation.

2. The recording medium according to claim 1, wherein
starting the second conversation includes determining the second script based on the transfer information and identification information corresponding to the second information processing terminal, when the transfer information and the identification information corresponding to the second information processing terminal are received from the second information processing terminal.

3. The recording medium according to claim 2, the process further comprising
causing the first information processing terminal to output transfer guidance for the first conversation, when conversation contents received from the first information processing terminal satisfy a predetermined condition after the first conversation starts, wherein
the transfer information is obtained based on the transfer guidance read by the second information processing terminal.

4. The recording medium according to claim 3, wherein
the transfer guidance is displayed as a Quick Response (QR) code by the first information processing terminal.

5. The recording medium according to claim 3, wherein
the first information processing terminal is caused to output the transfer guidance, when contents of a subsequent inquiry are judged to be related to personal information, based on the conversation contents.

6. The recording medium according to claim 3, wherein
the first information processing terminal is caused to output the transfer guidance, when contents of a subsequent inquiry are judged to be related to a shop or a service, based on the conversation contents.

7. The recording medium according to claim 2, wherein
the identification information corresponding to the first information processing terminal includes user attribute information obtained by the first information processing terminal, and
the identification information corresponding to the second information processing terminal includes user attribute information obtained by the second information processing terminal.

8. A conversation control method executed by a computer, the method comprising:
receiving, from a first information processing terminal, a start instruction for a chat and identification information corresponding to the first information processing terminal;
determining, based on the received identification information, a first script to be applied to a conversation performed by a chatbot via the first information processing terminal, and starting a first conversation performed by the chatbot via the first information processing terminal, using the determined first script; and
when receiving, from a second information processing terminal, transfer information that indicates transfer from the first conversation, determining, based on the received transfer information, a second script to be applied to the conversation performed by the chatbot via the second information processing terminal, and starting a second conversation performed by the chatbot, using the determined second script, the second conversation being performed via the second information processing terminal, following the first conversation.

9. An information processing apparatus comprising:
a memory; and
a processor coupled to the memory, the processor configured to:
receive, from a first information processing terminal, a start instruction for a chat and identification information corresponding to the first information processing terminal;
determine, based on the received identification information, a first script to be applied to a conversation performed by a chatbot via the first information processing terminal, and start a first conversation performed by the chatbot via the first information processing terminal, using the determined first script; and
when receiving, from a second information processing terminal, transfer information that indicates transfer from the first conversation, determine, based on the received transfer information, a second script to be applied to the conversation performed by the chatbot via the second information processing terminal, and start a second conversation performed by the chatbot, using the determined second script, the second conversation being performed via the second information processing terminal, following the first conversation.
